(19) United States
(12) Patent Application Publication
(10) Pub. No.: US 2025/0047634 A1
(43) Pub. Date: Feb. 6, 2025

(54) CONTROLLED COMMUNICATION METHOD AND SYSTEM

(71) Applicant: Artis Property Pty Ltd, Scone NSW (AU)

(72) Inventors: Jeffrey Douglas TOWLER, Scone (AU); Daniel Anthony TOWLER, Scone (AU)

(21) Appl. No.: 18/790,437

(22) Filed: Jul. 31, 2024

(30) Foreign Application Priority Data
Aug. 1, 2023 (AU) 2023210571

(51) Int. Cl. H04L 61/4594

(52) U.S. Cl. CPC H04L 61/4594

(57) ABSTRACT

Automated facilitated communication process, for use where a second person requests to communicate with a first person, but does not have contact details. A facilitation system provides the first person with a communication including a linking code, who can then optionally register in the system and use the linking code to enable communications through the system with the second person.

### CROSS REFERENCE TO RELATED APPLICATIONS

This application is a national filing of, and claims priority to, co-pending Australian Patent Application No. 2023210571, filed on Aug. 1, 2023, entitled, “CONTROLLED COMMUNICATION METHOD AND SYSTEM”, the disclosure of which is incorporated by reference herein in its entirety.

### TECHNICAL FIELD

The present invention relates to methods and systems which facilitate controlled communications between parties.

### BACKGROUND OF THE INVENTION

Communications between various parties are commonly undertaken in many forms. Apart from voice telephony, messages are exchanged using text messages (SMS), emails, and a wide variety of messaging applications, for example What's App and Telegram.

These communications techniques all require a degree of knowledge of the contact details of the recipient, for example their phone number or email address. In the scenario where a facilitating party wishes to introduce two people to each other who are previously unknown to each other, the simplest approach is to provide a contact address to one of the people for the other person.

However, in some circumstances, the facilitating party may wish to ensure that all the participating people have agreed to specific terms before putting them into communications. Further, it may be desired that contact can only be made if both persons agree. If a phone number or email address is simply passed on, then the parties may commence communications without any such agreement to terms, and the facilitating party has no mechanism to determine whether contact has occurred.

It is an object of the present to provide an automated process for facilitating communication between parties only if specific conditions are fulfilled.

### SUMMARY OF THE INVENTION

In a first broad form, the present invention provides a process in which a communication is sent to a first person from a facilitating system, indicating that a second person is interested in communicating with the first person. The communication includes a code. Both the first and second person must agree to terms, for example as part of the process of downloading and initialising an application (app). In this case, the app is adapted to read the code when provided by the first person, and thereby facilitate communications between the first and second person.

According to a first aspect, the present invention may comprise an automated facilitated communication process in an electronic communication facilitation system, including at least the steps of:
(a) A second person lodging an electronic request that they wish to communicate with a first person;
(b) In response to the request, retrieving or determining the contact details of the first person;
(c) Sending a message to the contact detail of the first person, indicating a request from a party to communicate and including a linking code;
(d) If he first person determines that they wish to communicate, then the first person uses the linking code to create an account in the system;
(e) The system then permitting communication between the first person and the second person using the system.

According to another aspect, the present invention may comprise an electronic communications facilitation system, operatively adapted to facilitate controlled communications between parties, the system including one or more servers, and a plurality of corresponding apps downloaded to remote devices associated with users, so that users can communicate with each other using the system, wherein if a user wishes to communicate with a party who is not a user, the system is adapted to generate a communication to the party, including a linking code, so that if the party downloads the app and utilises the linking code, the party may initiate communications with the user.

It can be seen that, in suitable implementations, such a message can be sent to a first person, who can choose to ignore it. There is no facility for the second person to initiate unwanted communications. Further, any such communication must be on terms agreed with the facilitating system provider. Thus, for example in a property sale facilitation system, the parties will have agreed to any fee charged by the facilitating system provider, and the system provider will be alerted that a communication has occurred between the parties, even if the system provider has no access to the content of the message.

### BRIEF DESCRIPTION OF THE DRAWINGS

An illustrative embodiment of the present invention will be described in connection with the accompanying figures, in which:

FIG. 1 is a schematic diagram illustrating the components of a system according to an implementation of the present invention; and

FIGS. 2 and 3 are flowcharts illustrating the operation of an app, from a user perspective.

### DETAILED DESCRIPTION OF THE INVENTION

The following description outlines an implementation of the present invention. It will be appreciated that this is not intended to be limitative of the scope, but rather to provide an illustrative example of one implementation. Many other implementations are possible, having regard to factors including the existing systems and applications to which the present invention may be applied.

It will also be understood that the detailed implementation, based upon the specific process steps and flowchart illustrated and described below, may be built using well understood tools and coding systems, and readily implemented by those skilled in the art. The functionality described may form part of a larger app or software platform, or be a stand alone system. Apps maybe downloaded from suitable app stores. The underlying system is preferably hosted in a cloud-based server.

The illustrative example relates to a controlled communication feature within a property app which assists parties who wish to buy or sell real estate. It will be appreciated that the technical aspects of the present invention may be implemented in many different situations, where a controlled communication is desired. For example, the present invention could be applied to sales of collectable items and artworks, to dating or other personal or employment matching applications, or to leases or share house situations for real estate. The present invention is concerned with the technical communications functions, not with the related commercial processes.

For the purposes of the present description and claims, the term controlled communication refers to a communication between two parties, where one party wishes to contact another, but does not have the contact details of the other party. This may be, for example, because they are not aware of the identity of the other person, or they do not have contact details for them. An intermediary, or facilitator, receives an electronic request from one party to communicate with a second party. The communication is controlled in that it is only permitted by the facilitating system if both parties have agreed to specific terms, including a wish to communicate with each other. Preferably, the facilitator is made aware that the communication has occurred.

According to the present implementation, the parties are potential purchasers, or customers, and potential sellers, or property owners.

Property owners can download the app, create an account, and register properties for sale. They can provide details about the property, such as location, price, and features. They can also upload photos of the property to give potential buyers a better idea of what it looks like. Property owners can add as many properties as they like to the app.

Customers can search for properties based on their preferences, such as location, type of property, and price range. They can then request to chat with the property owner to get more information about the property. Once the owner accepts the chat request, they can communicate with the chat feature provided within the app.

The chat feature allows users to send photos and audio clips of the property to each other. This is a useful tool for customers who want to get a better idea of what the property looks like before making a purchase decision.

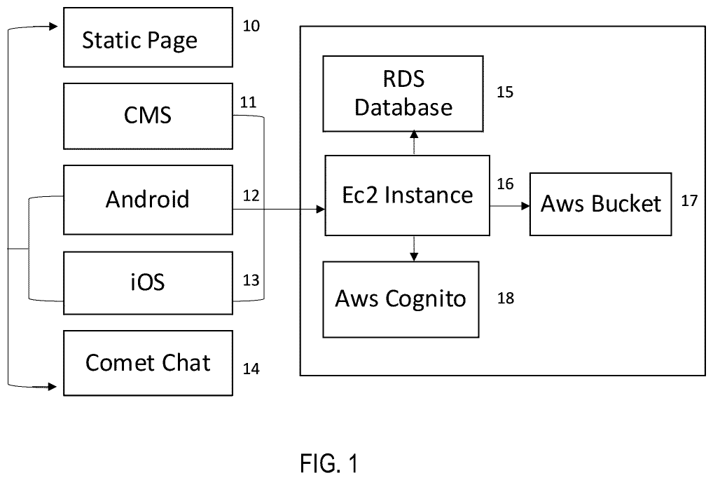

FIG. 1 is a diagram illustrating the components of the present system. Static pages 10 are presented within the app to users, under control of the Android 12 or iOS 13 implementations (smartphone implementations). A customer management system 11 (CMS) communicates with both implementations, as well as with the various cloud server-based components. The Ec2 instance 16 is a specific load provided by Amazon as cloud service provider, which can be scaled as required. This allows access to the AWS cognito identity platform 18, the RDS data base 15, the AWS bucket 17, and such other cloud services as are required. It will be appreciated that, so far, this is a generally conventional cloud-based app interaction. It will also be understood that alternative cloud systems could be used, for example Azure, and alternative smartphone, tablet or other operating systems could be supported, as is well known in the field.

The smartphone components also communicate with Comet chat 14, as will be explained further below.

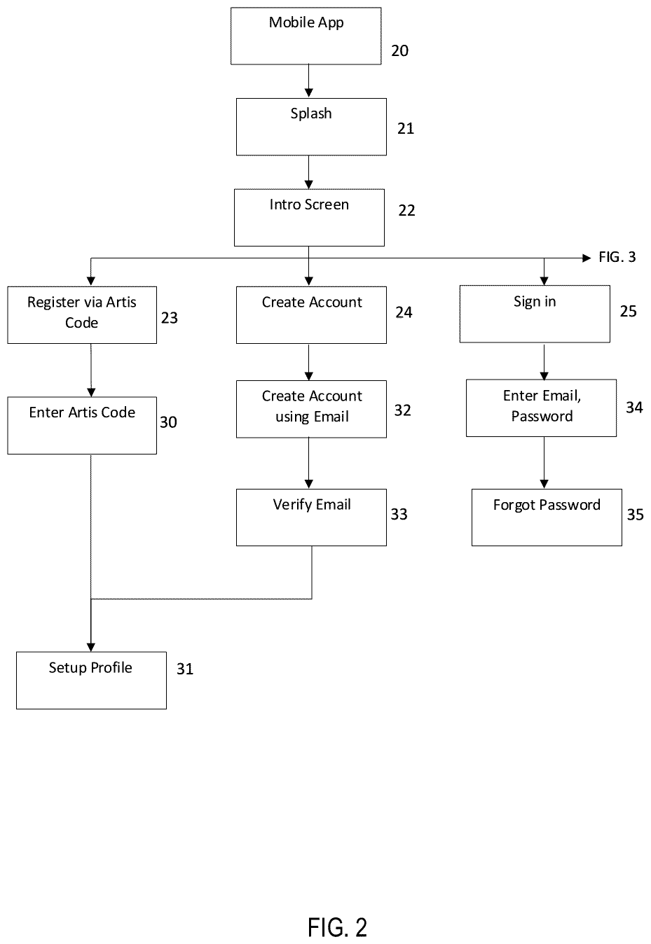

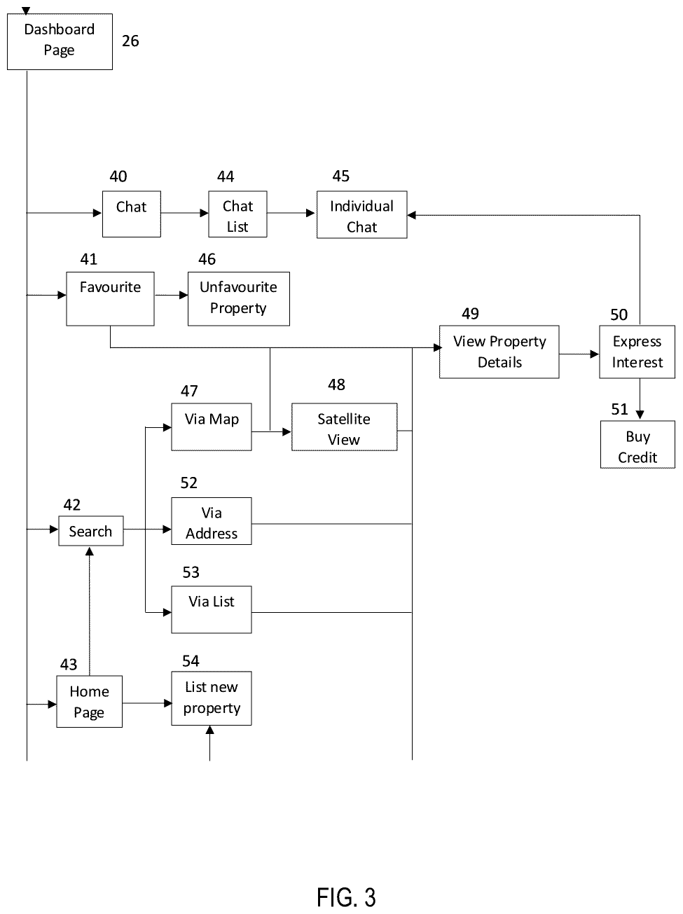

FIG. 2 shows a part of an app flow diagram, which continues onto FIG. 3, as marked on both flowcharts. Entering from a mobile app 20 (for example iOS or Android), the user reaches an introduction screen 22 via splash 21. This then leads to various options. The register via Artis code option 23 will be further explained below. Create account 24 starts a conventional account creation process, with the using creating an account using an email address at 32, verifying the email at 33, and then setting up a profile at 31.

Sign in 25 is for existing users, who enter an email and password at 34, or are directed to a forgot password procedure at 35 to reset their password. The dashboard page leads to further options, as can be seen in FIG. 3.

FIG. 3 shows the dashboard page 26, which links to options including chat 40, favourite 41, search 42 and home page 43.

Favourite 41 allows user to mark a property as a favourite, which links to the view property details function 49, and optionally to express interest 50. The search function 42 allows a user to locate a property via map 47, satellite view 48, address 52, or from a list 53. This in turn links to viewing property details 49 and the options following, as discussed above.

Home page 43 also supports an owner listing a new property, which process is not important for the present invention.

Chat 40 is driven by the chat list 44, which in turn is linked to the express interest process 50. A customer may search 42, as outlined above, view further details of the property 49, and favourite the property 41. If the property has been listed by the owner on the app, then a request to contact the owner will operate as a conventional chat message.

Importantly, for the purposes of the present invention, the app permits a customer to express interest not only in real estate, which is currently on the market, and so for which details of the agent or realtor or other contact details would be readily available, but also for properties which are not on the market at present. That is, a customer can express interest in a property, where the property owner is unaware that anyone has an interest in their property and where the owner has not listed or otherwise offered their property for sale.

When the property in the selected geolocation is off market, then an ‘Off Market’ popup will be displayed. When the user indicates, for example via an ‘express interest’ button, that they wish a message to be sent to the owner, the server generates an unique linking code. The linking code plays a vital role in enabling interactions and conversations pertaining to specific off-market properties. It serves as a key element in facilitating the smooth exchange of information and communication between users and property owners, allowing them to engage in discussions related to these properties that are not publicly listed on the platform.

The user expresses interest in a particular property by clicking the express interest button, part of the express interest process 50. According to the present implementation, use of the chat feature requires the purchases to buy credit for a specific chat relating to a specific property. However, in other implementations, this may be available as a general part of the application.

The express interest process includes a search by the server to determine whether the property has been listed by the owner in the database, in which case a communication is simply sent via the comet chat function to the owner who is registered on the app. If the user has credit (which can be purchased via in-app purchase), the system will proceed with the request (otherwise opening the buying page to purchase credit).

If, however, the property is not within the database, then the property is off market and the process below is initiated.

The server then creates a unique Linking Code and sets default property values relevant to the off market property, such as geolocation and address, which are stored on the server.

The linking code according to the present implementation is an alphanumeric code, generated by a random number generator within the server, for example 3A9UPMGV. It will be appreciated that many alternative code systems could be used, for example a barcode or QR code.

A specific chat room is created for that off-market property, adding only the user who has made the request for the property. Here the conversation has the chat for the current property only with the interested buyer and the property type is off [“i.e. off-market”] and initially the approved By Seller indicator is false.

The app uses suitable means to determine contact details for the owner. In a simple form, the contact details are the physical address of the property in question. In alternative implementations, the system may consult a public database of property ownership, or a proprietary database, or conduct a search to determine the contact details of the owner. It will be appreciated that it is not necessary in some implementations to determine the identity of the owner, so long as an address or other contact details can be determined.

The system then generates a standard letter to the property owner, including the unique linking code, and sends this to the property owner. If other communication details are known, for example an email address or mobile phone number, then this could alternatively be used to send the letter or other communication. The communication advises that someone is interested in discussing purchase of the property, provides the linking code and information on how to use the code. In the present implementation, the owner is directed to download the relevant app, so that the code can be utilised to initiate communications.

The property owner can decide to ignore the communication, in which case the process does not proceed further. If the property owner wishes to proceed, they download the corresponding app. A QR code or similar link may be provided to open in either the Apple Appstore or Google Play store, at the App Download Point for the present app.

The system then initiates a communication with the property owner. The new property owner clicks on the “Enter Linking Code” button. The owner then enters the linking code from the communication. The owner is prompted to enter basic personal profile details, as described with reference to FIG. 2. They further agree to Terms of Service and the Privacy Policy in order to create their account. After verification, the property owner is now added to the chat room and the chat room is listed in the recent chat list.

Of course, if the property owner is already an app user, then they can simply enter the linking code from the dashboard page.

The customer who initiated the expression of interest is notified that the property owner has joined Artis. The property owner receives an email to notify them of the message in their app chat inbox. In the App on the Ribbon Bar, the Recipient/Owner will see the notification of the message in their inbox, and they still have an option to engage or ignore the message from the customer. If the Owner Engages, the chat continues.

The Property Profile is itself automatically generated. The property owner needs to create a basic account to access the app and view the chat, but the property profile is created automatically, and they are assigned to it by accepting/scanning the linking code and creating the account.

From this the property owner has the ability to edit their Property Profile, but it is not mandatory.

Thus, the communication is only facilitated if and when both parties have agreed to the terms of service. In the present case, this means that both parties have agreed that a fee is payable to the app facilitator should the chat result in a sale of the property. This could be, for example, a fixed fee or a commission based on a percentage of the sale price.

The facilitator generates the unique code specific to the property and the potential purchaser, and is notified when the code has been used to register by the property owner, and used to commence a chat with the potential purchaser. Thus, there is a mechanism to determine whether the app has facilitated a contact, and to prove that such a contact was subject to the terms of service and hence the respective fees.

The app according to the illustrated implementation is free to download and free to search. The point of sale for the customer is when they choose to express interest in a property. For this they will need to purchase and use one (1) Credit. This credit covers the connection and all future communication with the registered owner of that property. The Payment Gateway is native to either Apple or Google, dependent on the user's device.

Whilst the present invention is described in a specific context, it will be understood that it may be applied to a variety of situations, where a party wishes to make contact, using a facilitator who has access to privileged, secret or restricted information.

It will also be appreciated that the invention may be equivalently implemented in various other forms. For example, the users may alternatively, or additionally simple register online and not use an app or a smartphone or similar device. Regular PC system systems could be used. In this case, the code could be facilitated by a link to a website.

1. A automated facilitated communication process in an electronic communication facilitation system, including at least the steps of:
(a) A second person lodging an electronic request that they wish to communicate with a first person;
(b) In response to the request, retrieving or determining the contact details of the first person;
(c) Sending a message to the contact detail of the first person, indicating a request from a party to communicate and including a linking code;
(d) If he first person determines that they wish to communicate, then the first person uses the linking code to create an account in the system;
(e) The system then permitting communication between the first person and the second person using the system.

2. A process according to claim 1, wherein at step (d), the second person is notified that the first person has created an account in response to the linking code.

3. A process according to claim 2, wherein the facilitation system is adapted to record the use of the linking code, and to record whether communications have occurred between the first and second persons.

4. A process according to claim 1, wherein the contact details are a physical address, and the message is sent by regular mail.

5. A process according to claim 1, wherein the first person is required to download an app in order to use the linking code, and to agree to specific conditions relating to a system provider.

6. A electronic communications facilitation system, operatively adapted to facilitate controlled communications between parties, the system including one or more servers, and a plurality of corresponding apps downloaded to remote devices associated with users, so that users can communicate with each other using the system, wherein if a user wishes to communicate with a party who is not a user, the system is adapted to generate a communication to the party, including a linking code, so that if the party downloads the app and utilizes the linking code, the party may initiate communications with the user.

7. A system according to claim 6, wherein the system is adapted to notify the user that the party has created an account in response to the linking code.

8. A system according to claim 7, wherein the system is adapted to record the use of the linking code, and to record whether communications have occurred between the user and the party.

9. A system according to claim 6, wherein the system generates a communication to the party using a physical address, and the message is sent by regular mail.

10. A system according to claim 6, wherein the first person is required to download an app in order to use the linking code, and to agree to specific conditions relating to a system provider.
